(19) United States
(12) Patent Application Publication
(10) Pub. No.: US 2007/0017147 A1
(43) Pub. Date: Jan. 25, 2007

(54) FISHERMAN'S FLYBOX WITH EXCHANGEABLE PADS

(76) Inventor: Guillermo Claudio Manzo, Buenos Aires (AR)

Correspondence Address: Michael D. Berger, Ph.D.;BAKER & MCKENZIE LLP, Pennzoil Place, South Tower, 711 Louisiana, Suite 3400, Houston, TX, 77002-2746, US

(21) Appl. No.: 11/458,514

(22) Filed: Jul. 19, 2006

(30) Foreign Application Priority Data
Jul. 19, 2005 (AR) P050102981

(51) Int. Cl. A01K 97/06

(52) U.S. Cl. 43/57.1; 43/54.1

(57) ABSTRACT

A flybox for keeping flies on pads therein. Magnets are arranged on the inner faces of the flybox where the pads are seated, giving the possibility of exchanging them easily and quickly. Thus the fisherman avoids having to buy and carry around numerous flyboxes, since with just one or two he is able to combine all variations and selections of dry and wet flies, keeping the rest of the pads which he will not use that day in his bag. Preferably four magnets are arranged on each inner flybox face and a like number distributed likewise on each exchangeable pad, with the poles of the magnets oriented for attraction. Alternatively, the pads may be metallic.

### FIELD OF THE INVENTION

The present invention refers to a portable case used by fishermen for carrying fishing hooks or flies to the scene of activity. It particularly refers to a so-called fly-box and to a flyholder pad for the same.

### BACKGROUND OF THE INVENTION

Fly fishermen must frequently adapt to varying fishing conditions, sometimes even during a single outing, requiring them to switch flies and techniques. Hence they typically have to carry several flyboxes to make the most of the opportunity. This is a particular inconvenience when going on fishing trips to places which are far away or not well known to the fisherman. Such a situation moves the fisherman to take a whole lot of different kinds of flies with him, filling up his jacket pockets with flyboxes.

These flyboxes are generally large, rigid and, in many cases, relatively heavy. They are usually made of metal or stiff plastics and carry inside a foam pad into which the flies are hooked for purposes of organization and later selection.

Hence, particularly in large numbers, flyboxes can be heavy and cumbersome. This is particularly inconvenient for the fisherman considering that it is usually likely that he will use a just small amount of the flies, risking wetting, damaging or losing flies that he will not be using should he accidentally fall, costing him money and ruining what should have been a joyful expedition.

Any fisherman would be glad to reduce weight both in his fishing jacket and in the bag or the like carrying his equipment, welcoming ways of lightening his load and optimize baggage space. Stuffing a lot of flies into a single flybox is inconvenient because it saturates the luggage, reducing the space for taking tackle and other fishing elements, besides making the fisherman spend a lot of money buying the necessary number of containers for his flies.

Means are known enabling the fisherman to exchange the fly storage means in the flyboxes. For instance, British (GB) patent No 190104786 discloses a fly-box with several fly-holder bars fitting like a comb into recesses where they are locked in place by a common sliding locking-bar similarly recessed so that the bars can be locked in or removed at will.

### SUMMARY OF THE INVENTION

Therefore, an object of this invention is to provide a lightweight, easy-to-use and low-cost flybox enabling use of exchangeable pads each holding multiple flies, such that the fisherman would just need one or two flybox irrespective of the number of fly-pads he has or takes with him. A further object of the invention is to provide exchangeable fly-pads for use with the flybox.

These and other objects and advantages that may become apparent in the course of the present description are achieved by arranging magnets on a surface of the flybox, preferably inside, to retain a pad therein in a way that it may be easily and swiftly exchanged with another. Thus the fisherman need not have nor carry numerous flyboxes around, just one or two are enough for him to combine a selection of dry and wet flies for the occasion, keeping the rest of the pads that he will not use that day in his bag or whatever, thereby occupying a minimum of space and reducing the weight thereof to practically nothing.

Another aspect of the invention refers to fly-pads removably mountable inside the flybox and exchangeable with similar fly-pads. Each fly-pad has a front face adapted for holding flies or hooks and a back face provided with magnetic means such as complementary magnets or a magnetic plate for engaging the flybox magnets.

The ensuing description refers to the accompanying drawings and evidences practical details for carrying out the invention by way of an example and in no way to limit the scope.

### BRIEF DESCRIPTION OF THE DRAWINGS

A more complete understanding of the apparatus of the present invention may be obtained by reference to the following detailed description taken together with the accompanying drawings wherein:

FIG. 1 is an upper plan view of the open flybox showing where the seats for the magnets are located, in relief relative to the rest of the flybox body, the closure hinge, side reinforcements and the central lock.

FIG. 2A is a plan schematic view of a three-stair fly storage pad.

FIG. 2B is a schematic view of a five-stair fly storage pad.

FIG. 3 is a plan schematic view of the back of the pads of either one of the pads of FIGS. 2A and 2B showing the location of the retaining magnets on the back.

FIG. 4 is an elevation schematic view showing how storage pads are exchanged and the location of magnets on both the pad and the plastic body of the flybox.

### DESCRIPTION OF AN EMBODIMENT OF THE INVENTION

Reference is now made in detail to embodiments of the invention, examples of which are illustrated in the accompanying drawings.

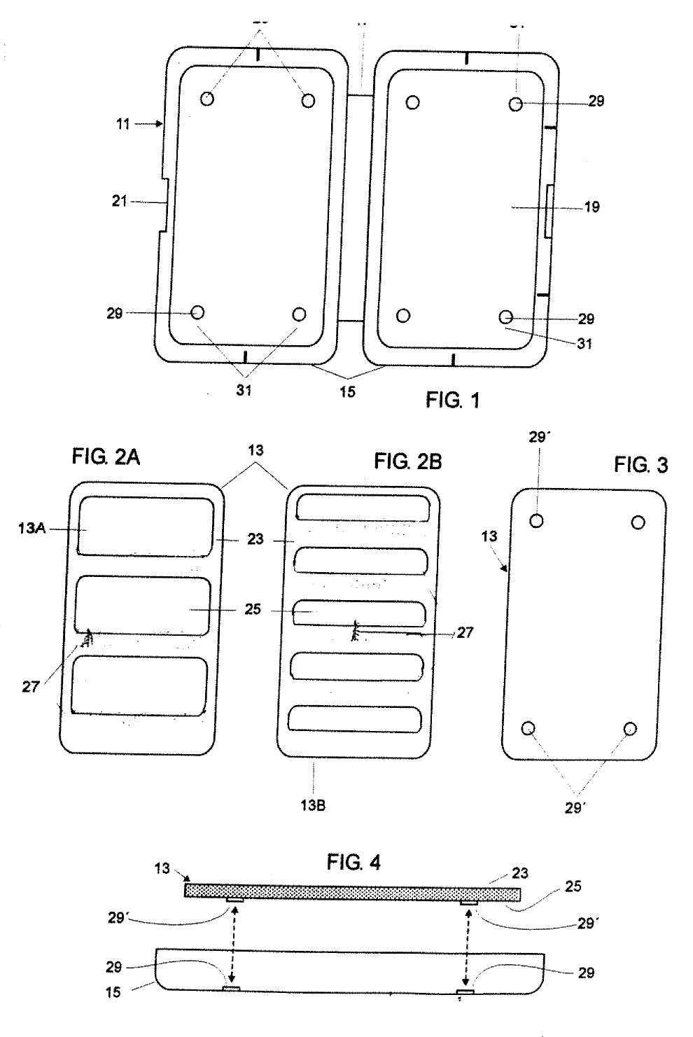

FIG. 1 illustrates the inside of a flybox 11 made of plastics and eva-gum for two removable rectangular pads 13, such as those illustrated in FIG. 2A or 2B. The flybox 11 comprises two body parts 15 articulated at a hinge 17. The outside aspect of the flybox 11 may be personalized by the fisherman so as to distinguish it from other fishermen's boxes 11.

The flybox 11 is manufactured of a material which is resistant to mishandling and temperature variations, preferably of high-impact plastics. It is made in one piece, in varied colours, without metallic parts for greater precision and stability for opening and closing. Its dimensions are 15 cm long, 9½ cm across and 3½ cm high. The flybox 11 has a pressure lock comprising a fin 19 projecting from the upper bodypart or lid 15A and engaging in a step 21 located in a recess of the facing body-part 15B.

The pads 13 are accessories to the flyboxes 11 inasmuch they may be for keeping flies of the “NINFA™” or “STREAMER™” type, as respectively illustrated in FIGS. 2A and 2B. The pads 13 are made of a combination of eva-gum and either high-impact plastics or a metal or ferromagnetic plate. Each pad 13 is manufactured as a rectangular unit 23 of a material into which the flies may be inserted, such as eva-gum (also known as plastic foam), which is punched into stairs and mounted to a back-plate 25 made of high-impact plastics, measuring 13½ cm long, 8½ cm across and ½ cm high in all. The STREAMER™ model pad 13A depicted in FIG. 2A has three stairs for lodging the flies 27, each stair able to hold fourteen flies per stair for an overall of forty-two flies per pad 13A. The NINFA™ model pad 13B represented in FIG. 2B has five stairs for housing the flies 27 and is capable of holding up to fourteen flies per stair, seventy flies in all per pad 13B.

The storage pads 13 are retained in place by four magnets 29 of neodymium, 6 mm in diameter and 1 mm thick each, applied in a rectangular configuration to the inner face of each part 15 that makes up the body of the flybox 11 and another four like magnets 29′ stuck to the plastic plate 25 of each pad 13, in the same position as the flybox magnets 29. Contact cement is used to affix the magnets 29 and 29′ respectively to the inside of the flybox body-part 15 and to the pad plates 23, taking care that like magnetic poles are not facing one another so as not to cause repulsion between engaging pairs of magnets 29-29′. The seats 31 of the magnets 29 located on the flybox 11 have a diameter of 7 mm and a height of 21 mm and are integrated into the flybox body 11 itself during injection molding thereof.

The weight of the flybox 11 is 72 grammes whereas each pad 13 weighs 2 grammes, the reduced weight for the fisherman to carry fulfilling an object of the invention.

The above embodiment is disclosed simply by way of example to enable one skilled in the art to understand and reduce the invention to practice. It is obvious that various changes and modifications may be made without departing from the scope of the invention.

I claim:

1. A flybox having an inside for holding fishing hooks or flies on at least one removable pad provided with magnetic means, the flybox including a surface comprising magnets arranged thereon for engaging said pad magnetic means.

2. A flybox according to claim 1, wherein said magnets are located inside the flybox.

3. A flybox according to claim 2 and comprising two articulated body-parts, each body-part having an inside face and an outside face, wherein said magnets are distributed over said inside face of at least one of said body-parts of the flybox.

4. A flybox according to claim 3, wherein said magnets are distributed over said inside face of both of said body-parts of the flybox.

5. A flybox according to claim 3, wherein said magnets are spaced apart in a rectangular configuration on said inside face of the body-part.

6. A flybox according to claim 1, wherein said magnets are magnetic disks.

7. A flybox according to claim 6, wherein said magnets are of neodymium.

8. A flybox according to claim 1, wherein said magnets are affixed to said flybox surface by means of contact cement.

9. A flybox according to claim 1, wherein said magnetic means comprise additional magnets affixed to said pads in a distribution analogous to that on the inner face of the flybox and with a magnetic polarity for attraction to the magnets of the flybox.

10. A flybox according to claim 1, wherein said magnetic means comprise ferromagnetic material adhered to or integrated into said pads.

11. A flybox according to claim 10, wherein said magnetic means comprise a metal plate adhered or integrated to said pads.

12. An exchangeable storage pad having a front face and a back face, said front face provided with means for storing flies or hooks, wherein the pad adapted for placing in a flybox having magnets for retaining said pad and said pad comprising magnetic means on its back face for engagement with the flybox magnets.

13. A pad according to claim 12, wherein said magnetic means comprise discrete magnets affixed to the back face of said pad in a distribution analogous to that on the flybox, said magnets having the magnetic poles of which are inverted in relation to the magnets of the flybox so as to be attracted thereby.

14. A pad according to claim 13, wherein said magnets are four magnets of neodymium affixed by means of contact cement near the four vertices of the pad.

15. A pad according to claim 12, wherein said magnetic means comprises ferromagnetic material adhered to or integrated into said pad.

16. A pad according to claim 15, wherein said ferromagnetic material comprises a metal back plate.
